(19) United States
(12) Patent Application Publication
(10) Pub. No.: US 2015/0024637 A1
(43) Pub. Date: Jan. 22, 2015

(54) CONNECTOR

(71) Applicant: Yazaki Corporation, Tokyo (JP)

(72) Inventor: Akihiro OSADA, Makinohara-shi (JP)

(73) Assignee: Yazaki Corporation, Tokyo (JP)

(21) Appl. No.: 14/336,388

(22) Filed: Jul. 21, 2014

(30) Foreign Application Priority Data
Jul. 22, 2013 (JP) 2013-151278

(51) Int. Cl. H01R 13/506; H01R 13/405

(52) U.S. Cl. CPC H01R 13/506; H01R 13/405
USPC 439/655

(57) ABSTRACT

A connector includes a housing having a sealing material potting area and a terminal assembling groove formed in the sealing material potting area, and a separate terminal formed separately from the housing and mounted into the terminal assembling groove. The separate terminal includes a resin portion and a terminal integrated with the resin portion. The terminal assembling groove includes a receiving portion which is opened on the sealing material potting area and into which the resin portion is fitted and a through hole which communicates with the receiving portion and through which the terminal is inserted.

### CROSS REFERENCE TO RELATED APPLICATION

This application is based upon and claims the benefit of priority from the prior Japanese Patent Application No. 2013-151278, filed on Jul. 22, 2013, the entire contents of which are incorporated herein by reference.

### BACKGROUND

1. TECHNICAL FIELD

The disclosure relates to a connector.

2. RELATED ART

In the connector described in Japanese Unexamined Patent Application Publication No. 2011-40246, an inner plate to which terminals are mounted is disposed in a housing according to the number of poles of the terminals and arrangement of the terminals.

### SUMMARY

In the above connector, since the terminals are mounted for each inner plate having predetermined size and shape, the inner plates corresponding to the maximum number of poles used in the connector are required to be assembled in the housing, and thus the assembling requires time and labor.

An object of the present invention is to provide a connector capable of easily corresponding to a plurality of applications.

A connector in accordance with some embodiments includes a housing having a sealing material potting area and a terminal assembling groove formed in the sealing material potting area, and a separate terminal formed separately from the housing and mounted into the terminal assembling groove. The separate terminal includes a resin portion and a terminal integrated with the resin portion. The terminal assembling groove includes a receiving portion which is opened on the sealing material potting area and into which the resin portion is fitted and a through hole which communicates with the receiving portion and through which the terminal is inserted.

The resin portion may have a locking portion protruding from a side surface of the resin portion and the receiving portion may have a locking groove portion which is formed on a side surface of the receiving portion and into which the locking portion is press-fitted.

The separate terminal may be insert-molded into the resin portion.

According to the above constitution, a connector is configured by assembling a separate terminal integrated with terminals through a resin in a terminal assembling groove. Thus, the connector can be easily assembled by previously providing a separate connector corresponding to the kind, size, and the number of poles of the terminal. Accordingly, the connector can be easily corresponded to a plurality of applications.

### BRIEF DESCRIPTION OF DRAWINGS

FIG. 1A is a front view of a connector according to an embodiment of the present invention.

FIG. 1B is a IB-IB arrowed cross-sectional view of FIG. 1A.

FIG. 1C is a IC-IC arrowed cross-sectional view of FIG. 1A.

FIG. 2A is a front view of a housing of the connector of FIGS. 1A to 1C.

FIG. 2B is a IIB-IIB arrowed cross-sectional view of FIG. 2A.

FIG. 2C is a IIC-IIC arrowed cross-sectional view of FIG. 2A.

FIG. 3A is a front perspective view of the housing of the connector of FIGS. 1A to 1C.

FIG. 3B is a IIIB-IIIB arrowed cross-sectional view of FIG. 3A.

FIG. 4 is an enlarged view of a terminal assembling groove portion of FIG. 3B.

FIGS. 5A to 5C are views showing separate terminals of FIGS. 1A to 1C.

FIG. 6 is a partial enlarged front view showing the separate terminals of FIG. 5A to 5C.

FIG. 7A is a perspective view of the separate terminal of FIG. 5A.

FIG. 7B is a VIIB-VIIB arrowed cross-sectional view of FIG. 7A.

FIG. 8 is a perspective view showing a method of assembling the connector of FIGS. 1A to 1C.

FIG. 9 is a rear perspective view of the connector of FIGS. 1A to 1C.

FIG. 10 is a partial enlarged view of the terminal assembling groove assembled with the separate terminal of FIG. 5.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Description will be hereinbelow provided for an embodiment of the present invention by referring to the drawings. It should be noted that the same or similar parts and components throughout the drawings will be denoted by the same or similar reference signs, and that descriptions for such parts and components will be omitted or simplified. In addition, it should be noted that the drawings are schematic and therefore different from the actual ones.

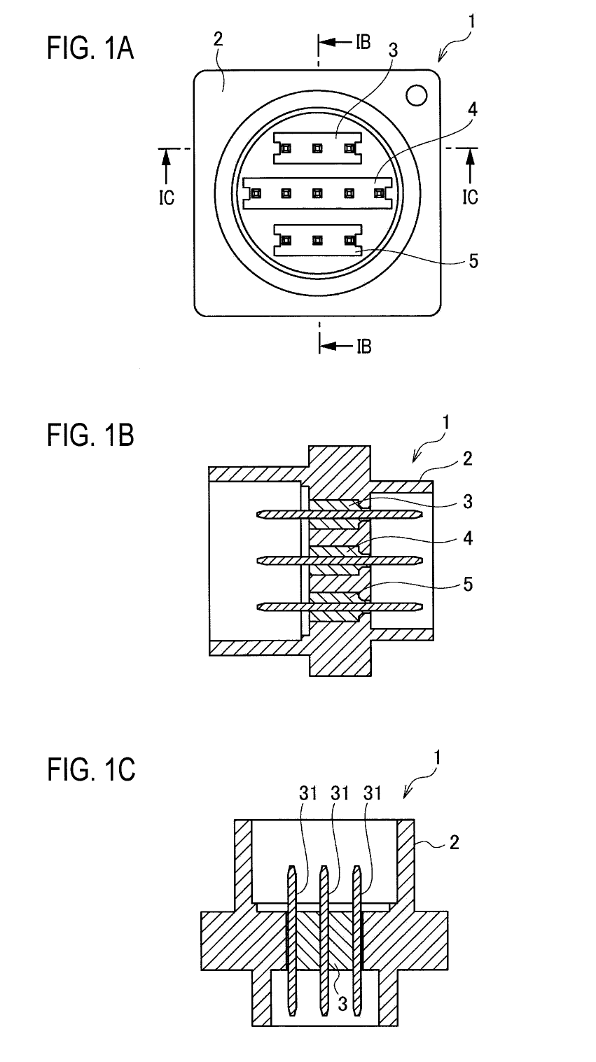

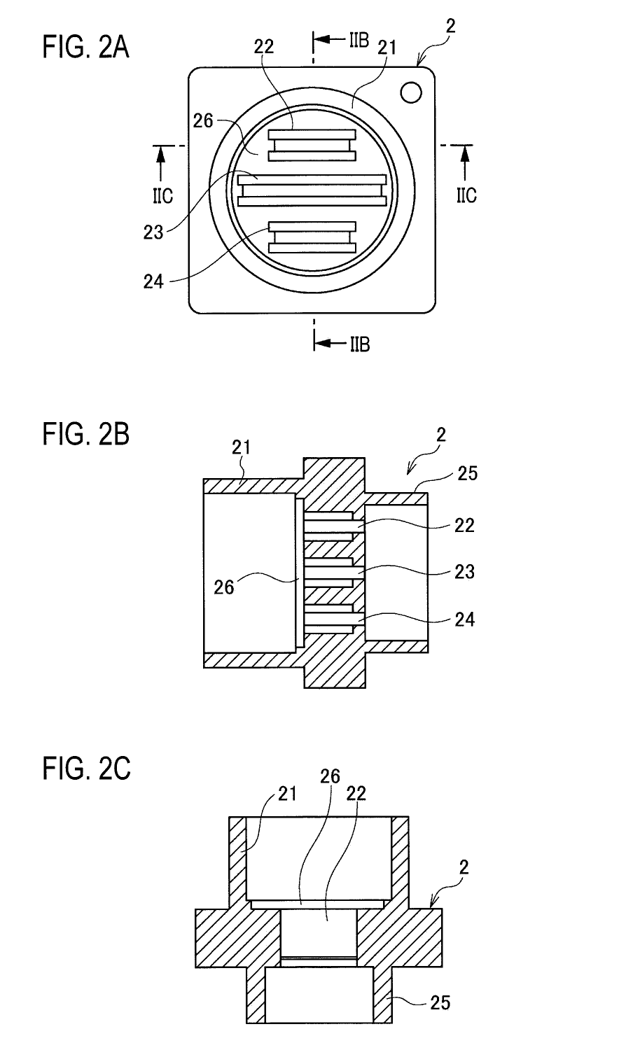

As shown in FIGS. 1A to 1C, a connector 1 is provided with a housing 2 and separate terminals 3 to 5 mounted in the housing 2. In the housing 2, as shown in FIGS. 1A to 1C and 2A to 2C, a first cylindrical portion 21 protrudes from one surface of a main body having a square block shape, and a second cylindrical portion 25 protrudes from the other surface of the main body.

The first cylindrical portion 21 and the second cylindrical portion 25 are formed coaxial with each other and extend from the housing 2, while having a cylindrical shape. The first cylindrical portion 21 has a cylindrical shape having a diameter larger than that of the second cylindrical portion 25. The first cylindrical portion 21 is formed to have a thickness slightly larger than that of the second cylindrical portion 25, and an inner diameter of the first cylindrical portion 21 is substantially equal to an outer diameter of the second cylindrical portion 25.

As shown in FIGS. 2A to 2C, a sealing material potting area 26 is provided on one surface of the housing 2 surrounded by the first cylindrical portion 21. The sealing material potting area 26 is an area for potting a sealing material 6 (see,

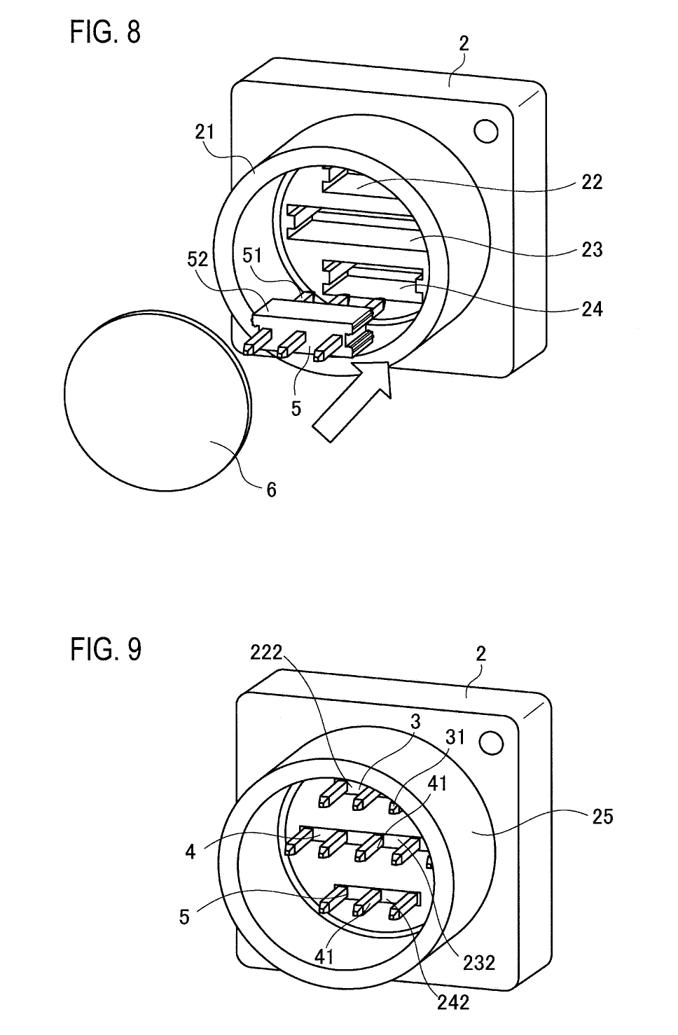

FIG. 8). The sealing material potting area 26 is surrounded by a step portion formed on an inner circumferential surface of the first cylindrical portion 21 . Thus, the sealing material potting area 26 is formed into a circular shape having an inner diameter slightly smaller than the inner diameter of the first cylindrical portion 21.

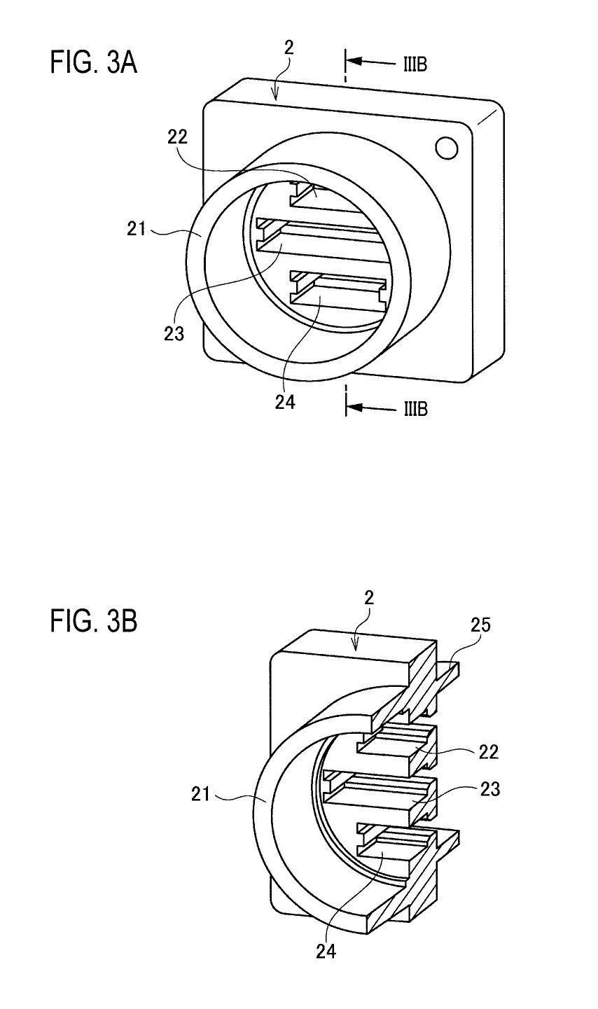

As shown in FIGS. 2A to 2C, 3A, and 3B, terminal assembling grooves 22 to 24 into which the separate terminals 3 to 5 (see, FIGS. 1A to 1C) are to be mounted are formed to be arranged vertically in the sealing material potting area 26. The terminal assembling grooves 22 to 24 are vertically arranged at equal angular intervals. The terminal assembling grooves 22 to 24 are grooves into which the separate terminals 3 to 5 are to be mounted and penetrate from one surface of the housing 2 to the other surface. The terminal assembling grooves 22 to 24 each have a rectangular opening shape.

The terminal assembling grooves 22 to 24 are formed at the same height. The terminal assembling grooves 22 and 24 arranged respectively above and below the terminal assembling groove 23 are formed to have the same width. The terminal assembling groove 23 is formed to have a width larger than each width of the terminal assembling grooves 22 and 24.

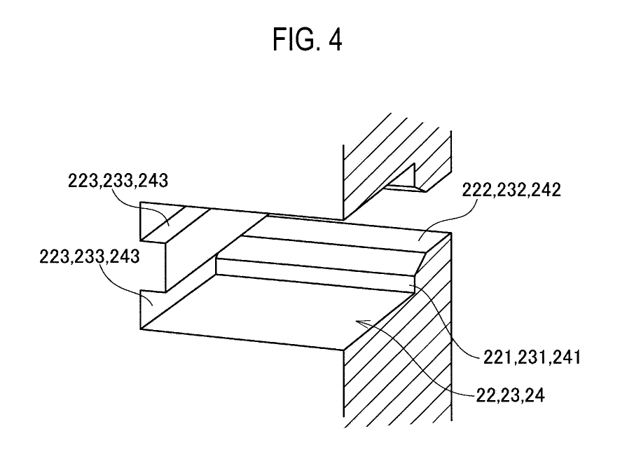

As shown in an enlarged view in FIG. 4, the terminal assembling grooves 22 to 24 are constituted of receiving portions 221, 231, and 241 opened on the sealing material potting area 26 and through holes 222, 232, and 242 communicating with the receiving portions 221, 231, and 241 and opened on the other surface of the housing 2.

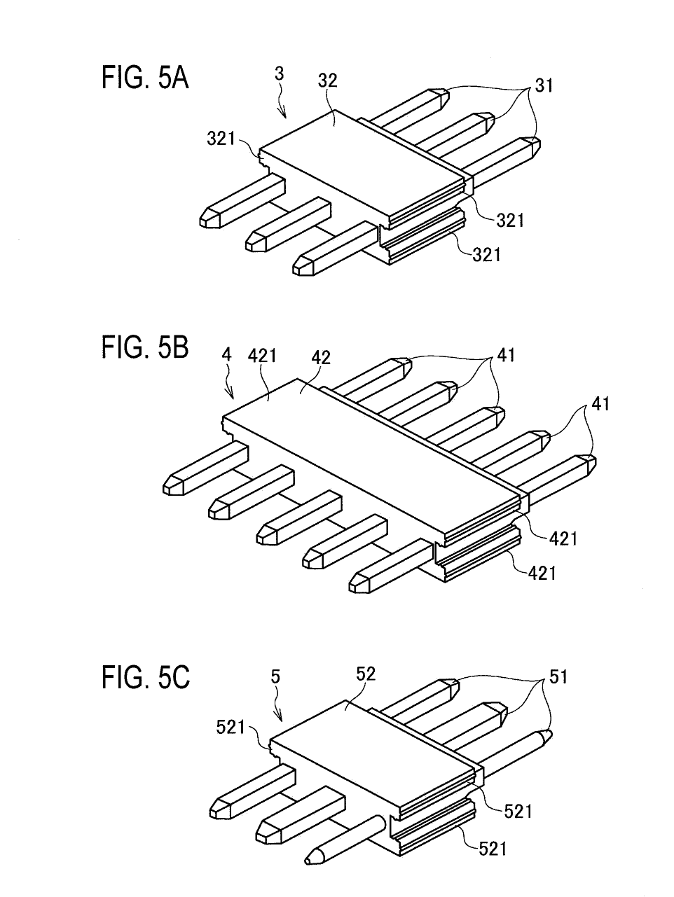

As shown in FIGS. 3A, 3B, and 4, the receiving portions 221, 231, and 241 each have a rectangular opening shape and extend from one surface side of the housing 2 to the other surface side. In the receiving portions 221, 231, and 241, resin portions 32, 42, and 52 (see, FIGS. 5A to 5C) of the separate terminals 3 to 5 to be described later are fitted. The through holes 222, 232, and 242 each have a rectangular opening shape smaller than the receiving portions 221, 231, and 241 and extend from the receiving portions 221, 231, and 241 to the other surface side of the housing 2. In the through holes 222, 232, and 242, terminals 31, 41, and 51 (see, FIGS. 5A to 5C) of the separate terminals 3 to 5, which will be described later, are inserted through the through holes 222, 232, and 242.

As shown in an enlarged view in FIG. 4, locking groove portions 223, 233, and 243 are formed on internal surfaces of four corners of the receiving portions 221, 231, and 241. The locking groove portions 223, 233, and 243 linearly extend from one ends of the receiving portions 221, 231, and 241 to the other ends and each have a rectangular cross-sectional shape.

As shown in FIGS. 5A to 5C, the separate terminals 3 to 5 are formed separately from the housing 2 and mounted into the respective terminal assembling grooves 22 to 24 (see, FIGS. 2A to 2C). The separate terminals 3 to 5 are constituted respectively of square block-shaped resin portions 32, 42, and 52 and terminals 31, 41, and 51 whose both end portions are protruded from end surfaces of the respective resin portions 32, 42, and 52.

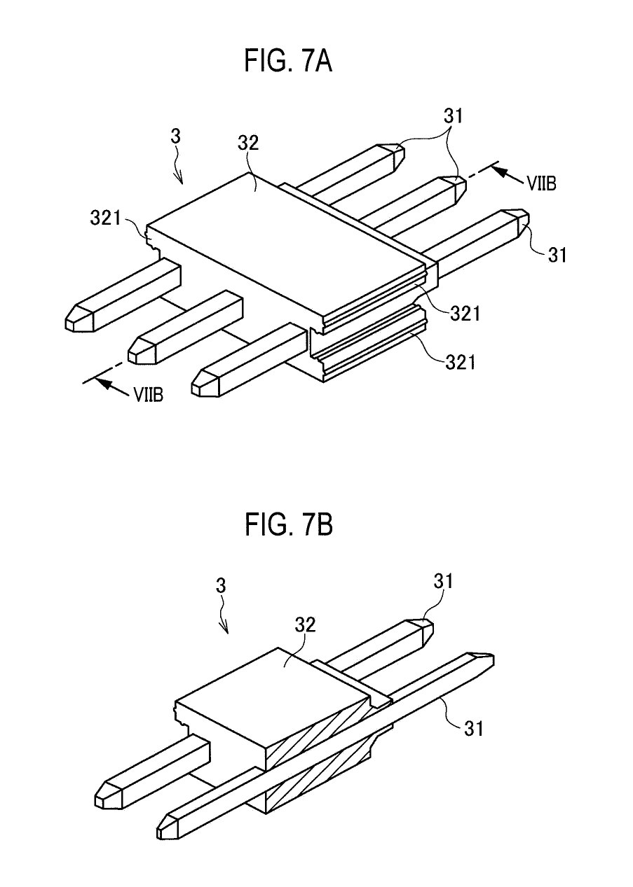

As shown in FIGS. 5A to 5C, 7A, and 7B, each of the resin portions 32, 42, and 52 specifically has a shape formed by combining a square block body having a front shape the same as the opening shape of each of the receiving portions 221, 231, and 241 and a square block body having a front shape the same as the opening shape of each of the through holes 222, 232, and 242 so that these square block shapes are arranged coaxial with an extending direction of each of the terminals 31, 41, and 51. A portion corresponding to a connecting portion between both the block bodies is formed into a tapered shape in the lateral view. As shown in FIGS. 5A and 5C, the separate terminals 3 and 5 are provided with the respective three terminals 31 and 51 arranged at equal angular intervals in width directions of the respective resin portions 32 and 52. The separate terminal 4 is provided with the five terminals 41 arranged at equal angular intervals in a width direction of the resin portion 42.

The protruding amounts of the terminals 31, 41, and 51 from both end surfaces of the respective resin portions 32, 42, and 52 are substantially equal to each other. Namely, the terminals 31, 41, and 51 protrude from the both end surfaces of the respective resin portions 32, 42, and 52 by a substantially equal length.

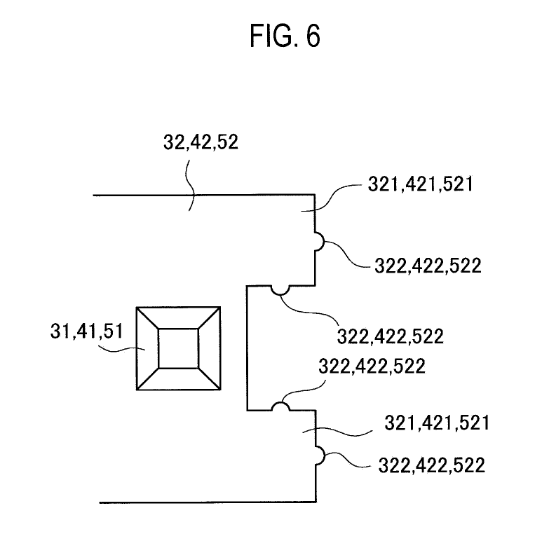

On the both side surfaces in the width directions of the respective resin portions 32, 42, and 52, locking portions 321, 421, and 521 protrude therefrom. The locking portions 321, 421, and 521 extend from both side portions of the both side surfaces in the width directions of the respective resin portions 32, 42, and 52. Further, on the side surfaces of the respective locking portions 321, 421, and 521, locking protrusions 322, 422, and 522 are formed as shown in an enlarged view in FIG. 6.

The locking protrusions 322, 422, and 522 are constituted of protrusions extending along the side surfaces of the locking portions 321, 421, and 521. The locking protrusions 322, 422, and 522 linearly extend from one end surfaces to the other end surfaces of the respective locking portions 321, 421, and 521 and each have a semicircular cross-sectional shape.

The terminals 31 and 41 each have a square cross-sectional shape, and both end portions of each of the terminals 31 and 41 are reduced in diameter. The terminal 51 includes one having a square cross-sectional shape and having both end portions reduced in diameter like the terminals 31 and 41, one having a rectangular cross-sectional shape and having both end portions reduced in diameter, and one having a circular cross-sectional shape and having both end portions reduced in diameter.

As shown in FIGS. 7A and 7B, the terminals 31 are insert-molded into the resin portion 32 to be thereby integrated with the resin portion 32 and penetrate through the resin portion 32. Similarly, the terminals 41 and 51 are insert-molded into the respective resin portions 42 and 52 to be thereby integrated with the respective resin portions 42 and 52 and penetrate through the respective resin portions 42 and 52.

Next, a method of assembling the connector 1 will be described.

First, as shown by an arrow in FIG. 8, a separate terminal 5 is inserted into a terminal assembling groove 24 from one end surface side of the housing 2. Then, the terminals 51 of the separate terminal 5 advance in the receiving portion 241 toward the through hole 242, and their tip ends are made to enter inside the through hole 242. After that, as the amount of insertion of the separate terminal 5 into the terminal assembling groove 24 increases, the terminals 51 move in the through hole 242 toward the second cylindrical portion 25 and penetrate through the through hole 242.

Similarly, the separate terminals 3 and 4 are inserted into the respective terminal assembling grooves 22 and 23 from one surface side of the housing 2. Then, the terminals 31 and 41 of the respective separate terminals 3 and 4 advance inside the respective receiving portions 221 and 231 toward the respective through holes 222 and 231, and the respective tip ends are made to enter inside the through holes 222 and 232. After that, as the amount of insertion of the separate terminals 3 and 4 into the respective terminal assembling grooves 22 and 23 increases, the terminals 31 and 41 move in the respective through holes 222 and 232 toward the second cylindrical portion 25 and penetrate through the respective through holes 222 and 232.

In the separate terminals 3 to 5 mounted into the respective terminal assembling grooves 23 to 25 as described above, the respective one ends of the terminals 31, 41, and 51 are located inside the first cylindrical portion 21, as shown in FIGS. 1A to 1C. As shown in FIG. 9, in the terminals 31, 41, and 51 penetrating through the respective through holes 222, 232, and 242, the tip ends are located inside the second cylindrical portion 25.

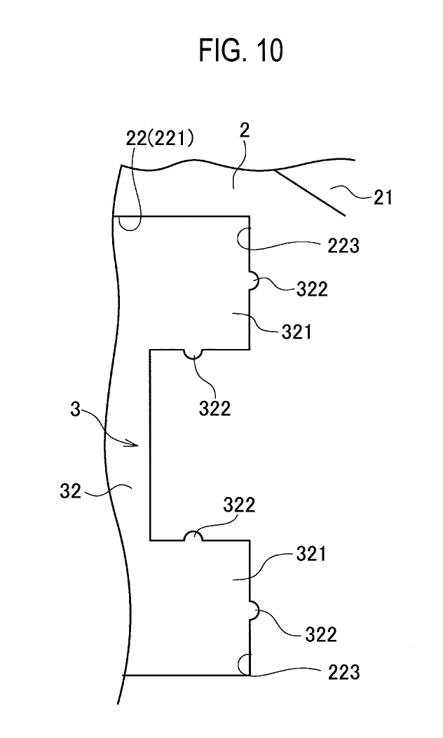

As shown in an enlarged view in FIG. 10, the locking portion 321 provided in the resin portion 32 of the separate terminal 3 is fitted into the locking groove portion 223, formed in the receiving portion 221 of the terminal assembling groove 22, and anchored to the receiving portion 221. The locking protrusion 322 is pressed down by being pressed against an inner surface of the locking groove portion 223 (in FIG. 10, the locking protrusion 332 is not pressed down for ease of understanding of a positional relation), and the locking portion 321 is press-fitted into the locking groove portion 223. According to this constitution, the separate terminal 3 is prevented from being released from the terminal assembling groove 22.

Similarly, the locking portions 421 and 521 provided in the respective resin portions 42 and 52 of the separate terminals 4 and 5 are fitted into the respective locking groove portions 233 and 243 formed in the respective receiving portions 231 and 241 of the terminal assembling groove 23 and 24. The locking protrusions 422 and 522 are pressed down by being pressed against respective inner surfaces of the locking groove portions 233 and 243, and the locking portions 421 and 521 are press-fitted into the respective locking groove portions 233 and 243. According to this constitution, the separate terminals 4 and 5 are prevented from being released from the respective terminal assembling grooves 23 and 24.

As described above, after all the separate terminals 3 to 5 are inserted into the respective terminal assembling grooves 22 to 24, the sealing material 6 is inserted into the first cylindrical portion 21, as shown by the arrow in FIG. 8, and the sealing material 6 is potted to the sealing material potting area 26. According to this constitution, the insides of the terminal assembling grooves 22 to 24 are sealed.

According to the embodiment, a plurality of the terminal assembling grooves 22 to 24 are formed in the sealing material potting area 26, and the separate terminals 3 to 5 separately formed from the housing 2 are mounted into the respective terminal assembling grooves 22 to 24. Thus, the connector 1 can be easily assembled by previously providing separate terminals 3 to 5 corresponding to the kind, size, and the number of poles of the terminal. Accordingly, the connector 1 can be easily corresponded to a plurality of applications.

Further, according to the embodiment, the locking portions 321, 421, and 521 protruding from the side surfaces of the respective resin portions 32, 42, and 52 are press-fitted into the respective locking groove portions 223, 233, and 243 formed on the respective side surfaces of the receiving portions 221, 231, and 241. Thus, the separate terminals 3 to 5 can be firmly fixed to the respective terminal assembling grooves 22 to 24.

In the above embodiment, although the case in which the three terminal assembling grooves 22 to 24 are formed in the sealing material potting area 26 has been described, the number of the terminal assembling grooves 22 to 24 is arbitrary. For example, two or less terminal assembling grooves may be provided, or four or more terminal assembling grooves may be provided.

The configuration of the separate terminals 3 to 5 is not limited to the above embodiment as long as the resin portions 32, 42, and 52 and the terminals 31, 41, and 51 are respectively integrated with each other and formed separately from the housing 2. The configuration of the terminal assembling grooves 22 to 24 is arbitrary as long as the resin portions 32, 42, and 52 of the respective separate terminals 3 to 5 are fitted into the respective terminal assembling grooves 22 to 24, and, in addition, the terminals 31, 41, and 51 are penetrated through the other surface side of the housing 2.

The configuration of the locking portions 321, 421, and 521 are arbitrary as long as they are formed on the side surfaces of the respective resin portions 32, 42, and 52 and press-fitted into the respective locking groove portions 223, 233, and 243 formed on the side surface of the receiving portion 241.

Embodiments of the present invention have been described above. However, the invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

Moreover, the effects described in the embodiments of the present invention are only a list of optimum effects achieved by the present invention. Hence, the effects of the present invention are not limited to those described in the embodiment of the present invention.

What is claimed is:

1. A connector comprising:
a housing having a sealing material potting area and a terminal assembling groove formed in the sealing material potting area; and
a separate terminal formed separately from the housing and mounted into the terminal assembling groove,
wherein the separate terminal includes
a resin portion and
a terminal integrated with the resin portion, and
wherein the terminal assembling groove includes
a receiving portion which is opened on the sealing material potting area and into which the resin portion is fitted and
a through hole which communicates with the receiving portion and through which the terminal is inserted.

2. The connector according to claim 1,
wherein the resin portion has a locking portion protruding from a side surface of the resin portion, and
wherein the receiving portion has a locking groove portion which is formed on a side surface of the receiving portion and into which the locking portion is press-fitted.

3. The connector according to claim 1, wherein the separate terminal is insert-molded into the resin portion.
